(19) United States
(12) Patent Application Publication
(10) Pub. No.: US 2005/0093288 A1
(43) Pub. Date: May 5, 2005

(54) Mud guard structure

(76) Inventor: Young Shin Kim, Guri-city (KR)

Correspondence Address: MORGAN, LEWIS & BOCKIUS LLP (SF), 2 PALO ALTO SQUARE, PALO ALTO, CA, 94306, US

(21) Appl. No.: 10/939,033

(22) Filed: Sep. 10, 2004

(30) Foreign Application Priority Data
Oct. 31, 2003 (KR) 10-2003-0076621

(51) Int. Cl. B62D 25/18

(52) U.S. Cl. 280/848

(57) ABSTRACT

A mud guard structure for an automobile, wherein rails are formed as one body on both sides of a top wheel arch cover, and a rail holder is formed on an inner side of a bottom wheel arch cover. These parts form a sliding open-close structure so that the top wheel arch cover may move along the rail, and a fixation means comprising a stud and a retainer is furnished in its cam nose part so that the top wheel arch cover may be easily combined or separated for operation of cargo vehicle, tractor, etc. without additional separation to improve upon appearance and maintain cleanness of a car body.

### CROSS-REFERENCE TO RELATED APPLICATIONS

This application claims priority of Korean Application No. 10-2003-0076621, filed Oct. 31, 2003, the disclosure of which is incorporated herein by reference.

### FIELD OF THE INVENTION

This invention relates to a mud guard structure, and, more particularly, to a mud guard structure for a cargo vehicle with dual axles.

### BACKGROUND OF THE INVENTION

In general, in case of a tractor, there is a wheel and cover for two axles, and the wheel arch cover plays the role of protecting a car body from mud or gravel.

For the 6×2 tractor recently developed, all of the axles in the rear are used for loading cargo, whereas, if cargo is not loaded, one of the two axles is used, and the other axle is designed to lift wheels so that fuel consumption and wearing of wheels may be prevented. Then, in such a structure that elevates wheels, the wheel arch cover does not employ a wheel arch cover in the form of closed structure but a wheel arch cover whose middle section is open by a certain length so there exists the problem of throwing mud and gravel to a car body and corroding and soiling a car body.

To resolve this problem, one proposed solution is a structure that enables attachment and detachment of a top wheel arch cover. Connection by a rubber connector makes it easy to detach, but rubber may deteriorate and snap, and its elasticity significantly decreases so it is not possible to connect a top wheel arch cover with a bottom wheel arch cover over time. In addition, it is also inconvenient because a rear shaft needs to be lifted up and a top wheel arch cover separated and stored in another location during tractor operation.

### SUMMARY OF THE INVENTION

In a mud guard structure for an automobile according to an embodiment of the present invention, rails are formed as one body on both sides of a top wheel arch cover, and a rail holder is formed on the inner side of a bottom wheel arch cover. A sliding open-close structure is thus formed so that the top wheel arch cover may move along the rail, and a fixation means, for example, a stud and a retainer, is furnished at a stepped edge so that the top wheel arch cover may be easily combined or separated for operation of a cargo vehicle, tractor, etc.

In a preferred embodiment of the invention, a rail is formed as one body on both sides of a top wheel arch cover. A rail holder is fixed by riveting that combines with the said rail on the inner side of the bottom wheel arch cover. A fixation means is mounted at the stepped edge of the top wheel arch cover that is fixed by mutual joining.

Preferably, the fixation means comprises a number of studs and retainers that are formed in equal intervals with respect to the contacting surface of the said top wheel arch cover.

In addition, the top wheel arch cover preferably includes a step part formed such that it corresponds to the stepped edge of one side and closely contacts with each other for a certain interval so that the surface meeting with each stepped edge of both sides may coincide with each other.

### BRIEF DESCRIPTION OF THE DRAWINGS

FIG. 1 is a perspective view of a mud guard structure for an automobile according to an embodiment of the present invention as seen from the top side direction.

FIG. 2 is a perspective view of a mud guard structure for an automobile according to an embodiment of the present invention as seen form the bottom side direction.

FIG. 3 is a perspective view illustrating a rail structure of the a guard structure for an automobile according to an embodiment of the present invention.

FIG. 4 is a perspective view illustrating a top wheel arch cover of a mud guard structure for an automobile according to an embodiment of the present invention.

FIG. 5 is a side cross-section view illustrating a stepped edge of a top wheel arch cover of a mud guard structure for an automobile according to an embodiment of the present invention.

### DETAILED DESCRIPTION OF THE PREFERRED EMBODIMENTS

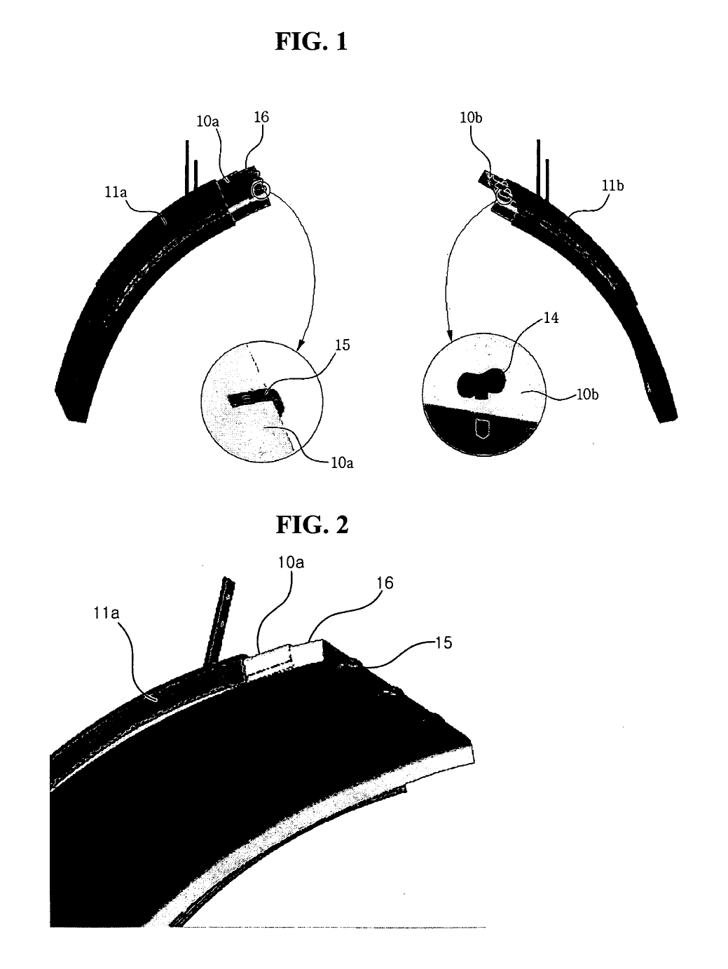

As illustrated in FIG. 1 and FIG. 2, in a preferred embodiment, the present invention includes a top part in an arch shape and a bottom part of wheel arch cover (10a, 10b, 11a, 11b). The top wheel arch cover (10a, 10b) slides and moves along a rail (12) at the bottom wheel arch cover (11a, 11b).

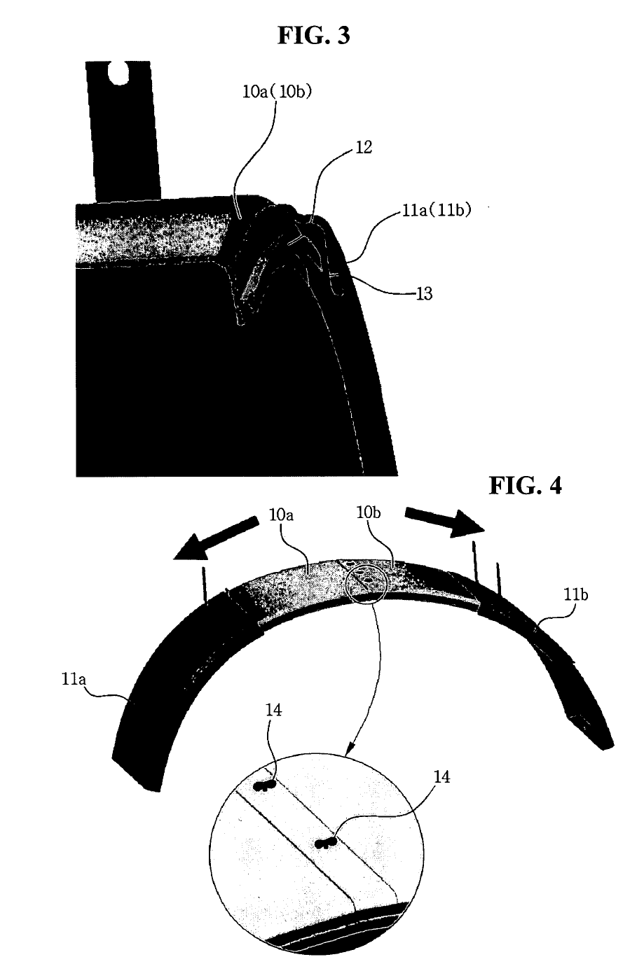

As illustrated in FIG. 3, as the top and bottom wheel arch covers (10a, 10b, 11a, 11b) are designed so that the top wheel arch covers (10a, 10b) may slide and move along a rail (12) mounted on the bottom wheel arch covers (11a, 11b). The rail (12) is formed at both sides of the top wheel arch covers (10a, 10b), preferably in one body as a unitary number. A rail holder (13) that receives rail (12) is fixed on the inner sides of the bottom wheel arch covers (11a, 11b). The rail holder may be secured to the bottom wheel arch covers, for example by riveting.

For the top wheel arch covers (10a, 10b), that open and close to the left and right at the bottom wheel arch covers (11a, 11b) fixed as such, a fixation means is mounted along a stepped edge that is fixed together by mutual joining. The fixation means is preferably configured with common studs (14) and retainers (15), but other means may be employed. Also preferably, the fixation means is formed at equal intervals with respect to the meeting surface of the top wheel arch covers (10a, 10b).

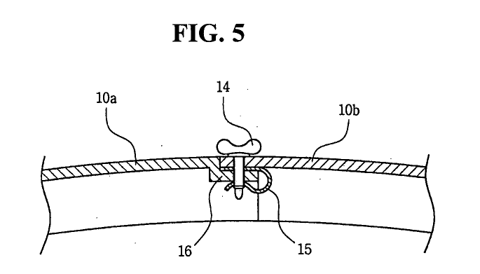

As illustrated in FIG. 4 and FIG. 5, a step part (16) in a stepped shape is formed on one side so that the meeting surface of each edge may coincide with the other when the top wheel arch covers (10a, 10b) are fixed by the fixation means. Furthermore, it is formed such that they correspond to each other and coincide by contacting closely.

In case of normal operation of a tractor, the top wheel arch covers (10a, 10b) respectively coincide with each other so as to be fixed by studs (14) and retainers (15). If wheels of one of two axles are lifted without loading cargo, studs (14) and retainers (15) of the top wheel arch covers (10a, 10b) are released. Each stud (14) is secured so as not separate from its joining hole before each of the top wheel arch covers (10a, 10b) is pressed into the corresponding bottom wheel arch cover (11a, 11b) in both directions along the rail (12) so that the wheel arch covers (10a, 10b) may have an open structure.

Therefore, top wheel arch covers (10a, 10b) are not separated, but pressed into bottom wheel arch covers (11a, 11b) through a rail (12) to utilize an open structure in this invention, while, if a close structure is utilized, top wheel arch covers (10a, 10b) are respectively allowed to coincide with each other and used by fixing them with a fixation means. So this invention provides a new mud guard structure for an automobile in comparison to available arts in that combination and separation is easily carried out without cumbersome separation of top wheel arch covers (10a, 10b).

As described above, according to the mud guard structure for an automobile of this invention, a rail holding is installed on a bottom wheel arch cover, and a sliding open and open structure is configured to enable a top wheel arch cover to move along a top rail so that combination and separation may be easily carried out without cumbersome separation of a top wheel arch cover during operation, and therefore improvement on appearance and maintenance of a clean car body may be effectively promoted.

In particular, a fixation means such as a common turn fastener may be used to join and disassemble wheel arch covers with ease, and, furthermore, the issue of storing wheel arch covers may be resolved.

1. A mud guard structure for an automobile, wherein a rail is formed as one body on both sides of a top wheel arch cover, a rail holder that receives the rail secured on an inner side of a bottom wheel arch cover, and a fixation means is mounted along an edge of the top wheel arch cover.

2. The mud guard structure for an automobile as recited in claim 1, wherein the fixation means comprises a number of studs and retainers that are formed in equal intervals with respect to a contacting surface of the top wheel arch cover.

3. The mud guard structure for an automobile as recited in claim 1, wherein the top wheel arch cover includes a step part formed such that it corresponds to an opposite side stepped edge part, the opposing stepped parts closely contacting each other.

4. A mud guard structure for an automobile, wherein a rail is formed as one body on both sides of a top wheel arch cover, a rail holder that combines with the rail secured on an inner side of a bottom wheel arch cover, and a fixation means is mounted along a stepped edge of the top wheel arch cover, said stepped edge being fixable to a complimentary stepped edge by mutual joining.

5. The mud guard structure for an automobile as recited in claim 4, wherein the fixation means comprises a number of studs and retainers that are formed in equal intervals with respect to a contacting surface of the top wheel arch cover.

6. The mud guard structure for an automobile as recited in claim 4, wherein the top wheel arch cover includes a step part formed such that it corresponds to a stepped part of one side and closely contacts with the other for a certain interval so that the surface meeting with each edge part of both sides may coincide with each other.

7. A mud guard structure, comprising:
a pair of opposed bottom wheel arch covers defining a space there between;
rail holders disposed along facing inside edges of each said bottom wheel arch cover;
a pair of top wheel arch covers including integrally formed rails along opposite outside edges, said rails being slideably received in said rail holders such that the top wheel covers may be slid together to close said space or slid apart to open said space; and
fixation means disposed on facing edges of the top wheel arch covers.

8. The mud guard structure of claim 7, wherein the fixation means comprises a plurality of studs on one edge and a plurality of receiving retainers on the facing edges.

9. The mud guard structure of claim 7, wherein the fixation means comprises the facing edges being stepped for mutual joining.

10. The mud guard structure of claim 9, wherein the fixation means further comprises a plurality of fasteners disposed along said stepped edges.
